(19) United States
(12) Patent Application Publication
(10) Pub. No.: US 2013/0104238 A1
(43) Pub. Date: Apr. 25, 2013

(54) METHOD AND APPARATUS FOR VERIFYING PROOF OF PRESENCE

(71) Applicants: Damien Balsan, Belmont, MA (US); Indrajit Chaudhuri, Espoo (FI); Banu Prasad Dhanakoti, Woburn, MA (US); Tapio Mika Kalevi Tolvanen, Cupertino, CA (US)

(72) Inventors: Damien Balsan, Belmont, MA (US); Indrajit Chaudhuri, Espoo (FI); Banu Prasad Dhanakoti, Woburn, MA (US); Tapio Mika Kalevi Tolvanen, Cupertino, CA (US)

(73) Assignee: Nokia Corporation, Espoo (FI)

(21) Appl. No.: 13/280,330

(22) Filed: Oct. 24, 2011

(51) Int. Cl. G06F 21/00; G06F 7/04

(52) U.S. Cl. 726/26

(57) ABSTRACT

An approach is provided for facilitating a verification of proof of presence of a user device that can be unspoofable and/or encrypted. A tag verification platform processes information associated with one or more memory tags, one or more vendors, one or more service providers and one or more user device, or a combination thereof related to a verification of proof of presence wherein the verification can be utilized by one or more vendors and/or service providers to provide one or more products and/or one or more services to one or more users.

### BACKGROUND

Wireless (e.g., cellular) service providers and device manufacturers are continually challenged to deliver value and convenience to consumers by, for example, providing compelling services, applications and content. One area of focus is the development of services and technologies for delivery of location-based services (e.g., offers, discounts, check-ins, etc.) that depend on, for example, verifying that a device receiving the services is physically located at or has visited one or more locations. Evidence supporting such verification is often referred to as proof of presence. By way of example, proof of presence technology enables mobile device users to take advantage of incentives and coupons offered by merchants on the basis of their determined physical presence at a designated location, e.g., a store location.

### SOME EXAMPLE EMBODIMENTS

Therefore, there is a need for an approach for determining proof of presence information that verifies that a device has visited a particular location.

According to one embodiment, a method comprises processing and/or facilitating a processing of proof of presence information to determine at least one location identifier, at least one device, or a combination thereof. The method also comprises causing, at least in part, a comparison of the at least one location identifier against a location verification registry. The method further comprises causing, at least in part, a verification that the at least one device was present at one or more locations associated with the at least one location identifier based, at least in part, on the comparison.

According to another embodiment, an apparatus comprises at least one processor, and at least one memory including computer program code for one or more computer programs, the at least one memory and the computer program code configured to, with the at least one processor, cause, at least in part, the apparatus to process and/or facilitate a processing of proof of presence information to determine at least one location identifier, at least one device, or a combination thereof. The apparatus is also caused to cause, at least in part, a comparison of the at least one location identifier against a location verification registry. The apparatus is further caused to cause, at least in part, a verification that the at least one device was present at one or more locations associated with the at least one location identifier based, at least in part, on the comparison.

According to another embodiment, a computer-readable storage medium carries one or more sequences of one or more instructions which, when executed by one or more processors, cause, at least in part, an apparatus to process and/or facilitate a processing of proof of presence information to determine at least one location identifier, at least one device, or a combination thereof. The apparatus is also caused to cause, at least in part, a comparison of the at least one location identifier against a location verification registry. The apparatus is further caused to cause, at least in part, a verification that the at least one device was present at one or more locations associated with the at least one location identifier based, at least in part, on the comparison.

According to another embodiment, an apparatus comprises means for processing and/or facilitating a processing of proof of presence information to determine at least one location identifier, at least one device, or a combination thereof. The apparatus also comprises means for causing, at least in part, a comparison of the at least one location identifier against a location verification registry. The apparatus further comprises means for causing, at least in part, a verification that the at least one device was present at one or more locations associated with the at least one location identifier based, at least in part, on the comparison.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-13, 27-39, and 58-60.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of facilitating verification of proof of presence, according to one embodiment;

FIG. 2 illustrates components of proof of presence module, according to one embodiment;

FIG. 3 is a flowchart of a process for processing proof of presence information of a user device, according to one embodiment;

FIG. 4 is a flowchart of a process for submission of the verification of PoP to one or more service providers, according to one embodiment;

FIG. 5 depicts an example architecture 500 of proof of presence with a service provider application, according to one embodiment;

FIGS. 6A-6F are diagrams of user interfaces utilized in the processes of FIGS. 3 and 4, according to various embodiments;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for facilitating verification of proof of presence of a user device (e.g., based on radio frequency memory tag detection, visual image capture, etc.) are disclosed. Services often rely on proof of presence information to trigger delivery of services, items, etc. such as promotional information to devices based on, for instance, their location (e.g., location at a store). In one embodiment, promotional information may include for example, any data for indicating details regarding one or more products, goods, services or a combination thereof. This may include for example, pricing data, product details, manufacturing details, transaction instruction data, etc. In addition, promotional information may include a discount, offer, coupon, incentive or other benefit to be derived by a user in response to execution of a transaction relating to one or more services, products, goods or a combination thereof. As will be discussed more fully, promotional information representing a service, product, good or distributor of such goods may be used to trigger seamless execution of a verification of proof of presence independent of a merchant point of sales system.

In the following description, for the purpose of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Generally, there are various methods to associate a user and/or a user device with one or more location information items in order to determine if the user device/user has physically visited a particular location (e.g., geo-fencing); however, a more accurate and practical proof of presence solution, for example, would be for a user device to obtain and submit one or more location specific information items (e.g., memory tag information, GPS, images, etc.) for authentication (e.g., via cloud-based authentication). Further, the accuracy and security of a solution can be very important for one or more parties such as advertisers, merchants, vendors, service providers and the like who may wish to utilize a proof of presence for/before offering one or more rewards and/or promotional products and/or services to one or more users.

In various embodiments, verification of proof of presence (PoP) of a user device at a designated location is performed by way of various presence detection techniques, including near field communication (NFC), radio frequency identification (RFID) memory tag, image captures, etc. used to verify that a user currently is at and/or has been at a particular location. For example, RFID memory tags may be affixed to or near a product for being detected by a mobile device. Upon detection, a merchant and/or a service provider may initiate one or more processes for interfacing with the user via the user device located near the product. As another example, a device may capture images of predetermined markers (e.g., posters, items, etc.) available at a particular location. Analyzing the images for those markers can them constitute proof that the device was at least near enough to the marker capture the image. In some embodiments, the markers may be variable to decrease the likelihood of receiving potentially fraudulent proof of presence.

In various embodiments, integrity of a PoP verification solution may be improved by utilizing a memory tag which has one or more security parameters, for example, the memory tag and/or one or more information items associated with memory tag cannot be can copied, reproduced (e.g., unspoofable) wherein the security parameters may be embedded in the one or more information items, in the memory tag (e.g., hardware, firmware, silicon, etc.). In another example, once the memory tag is programmed with one or more parameters and/or information items; for example, hard-coded into an integrated circuit; wherein an authentication process (e.g., cloud-based) can determine and provide a memory tag ID and one or more other information items (e.g., encoded information) which may be associated together and stored in a database utilized for verification of proof of presence and wherein the one or more information items could not be duplicated after it has been associated and stored in the database. In another embodiment, a vendor and/or service provider would perform a verification process before providing a new authentication for a new memory tag and associated information.

Further, the verification may also serve as a “check-in” process wherein advertisers, merchants, vendors, service providers, or third parties may be willing to award higher value premium products and/or services when certain patterns of check-in have been verified. Moreover, the verification process also allows proven redemption of goods awarded digitally such that a merchant may easily verify. The process further facilitates simple accounting for merchants and advertisers.

Further, service providers such as Foursquare©, Facebook© and the like have been increasingly making location based offers to users where incentives are provided to users for physically visiting certain locations (e.g., merchants, service providers, etc.) in order to increase potential customer visits; however, without verified actual visits, the service providers would be reluctant to offer more valuable incentives (e.g., products or services as part of a customer loyalty program) for fear of abuse. Therefore, device manufacturers need to provide a system for verification of proof of presence indicating with substantial certainty that the verification process has not been tampered with and assuring a high level of confidence for the service providers.

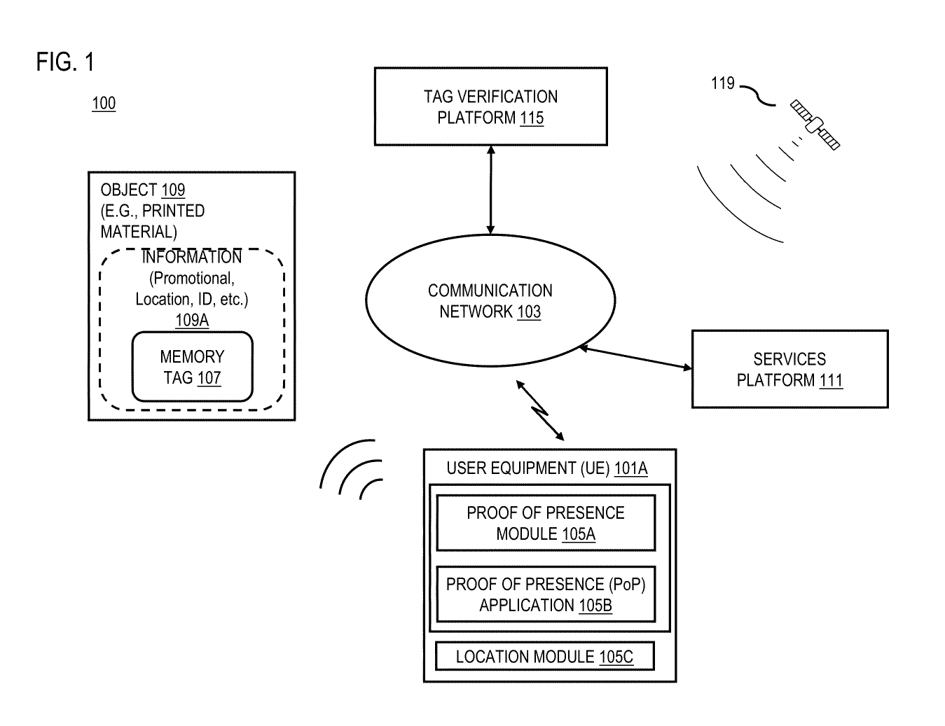

FIG. 1 is a diagram of a system capable of facilitating a verification of PoP, according to one embodiment. The system 100 is configured to enable user devices, i.e., user equipment (UE) 101A to detect and communicate with one or more memory tags 107a-107n (also collectively known as memory tags 107) for receiving and/or presenting one or more information items for utilization in verification of PoP of the user device at a certain location. For example, the user device may receive one or more information items (e.g., a serial code, a location code, a product code, a memory tag code, etc.) from the memory tag and then forward at least the one or more information items to a tag verification platform for verification of PoP of the user device at the same location as the memory tag. In another example, the user device may detect one or more memory tags and submit one or more user device and/or user information items to the one or more memory tags so that the one or more memory tags may forward at least the one or more user device and/or user information to tag verification platform for verification of PoP of the user device at a the same location as the memory tag.

In certain embodiments, the memory tag identifier may include, for example, a barcode such as an International Article Number (EAN) or a Universal Product Code (UPC), a matrix code such as a 2D barcode or Quick Response (QR) code, an alphanumeric or textual identifier value, or a combination thereof. Further, the memory tag may be constructed, fixed and designated to a certain location such that if an attempt is made to improperly remove and/or relocate it, then the memory tag would stop functioning and/or would be able to indicate a tampering and/or indicate its change of location.

As a means of enticing consumers, many merchants and service providers employ proof of presence (PoP) based marketing and incentive provisioning techniques. Proof of presence, by way of example, includes various techniques for triggering the activation of promotional information (e.g., retrieval or redemption of a coupon, delivery of a product and/or a service) based on the determined physical presence of the user at a designated location. Hence, under this scenario, promotional information may directly be linked to a particular merchant, merchant location, venue, etc. Typically, verification of a user's presence at the designated location is performed by way of various presence detection techniques, including near field communication (NFC) and radio frequency identification (RFID) memory tag use. RFID memory tags may be affixed to or near the product for being detected by a mobile device of the user as they are physically present at the designated location. In other instances, the memory tags may be used in conjunction with other data capture techniques (e.g., GPS) to initiate the verification of the PoP. Unfortunately, a typical verification of PoP process can be tampered with wherein a user may be able to provide one or more altered information items and falsely appear to be and/or appear to have been at one or more certain locations.

The system 100 of FIG. 1 addresses this problem by enabling verification of PoP of one or more user devices based on the data read from and/or associated with an RF memory tag. Data read from an RF memory tag 107 may include promotional information such as a coupon, incentive, product details, memory tag identification information, location information, service provider information, etc. Reading of a tag 107 may be facilitated through physical activation, including tagging, touching, tapping or other contact by a tag processing capable device 101A or via a proximity/presence detection capability of the device 101A (e.g., near field communication). An RF memory tag 107, as associated with a particular item (object) 109 and/or a physical location, has sufficient memory to store information 109A (e.g., physical location, time, date, text, video, still pictures, voice media, databases, documents, software, purchasing data, product data, store data, inventory information, etc.) regarding the associated item and the physical location, wherein the a memory tag 107 may be affixed to an in-store billboard, kiosk, product and the like located at a particular physical location. As an example, an RF memory tag 107 may be associated with (e.g. embedded in, attached to, or printed on) any of a variety of objects capable of supporting the tag (e.g., packaging material, a sticker, a poster, a card, a magazine, a newspaper, products, clothing, kiosks, booths, vending machines, etc.). By linking to a specific location or resource, the memory tag 107 and associated information 109A can serve as an initiation point for verification of PoP of a user device. Furthermore, proof of presence verification in conjunction with various authentication techniques and security protocols prevents spoofing or unauthorized execution of promotional information embedded in 109A.

Memory tags 107 may be supplied by a merchant and/or a service provider directly or affiliates thereof. For example, the merchant may function as a distribution channel, retail outlet, vendor or the like that is affiliated with multiple different services and goods providers that rely on the merchant for distribution. Under this scenario, the different affiliates supply the merchant with various memory tags 107 or tagged posters, banners kiosks, booths and other objects 109 for enabling user device activation of promotional information 109A and/or begin verification of PoP of user device. The objects 109 may correspond to a particular marketing and/or promotional campaign of the affiliate and may include for example a poster for placement at various locations throughout a shopping mall, for placement at the entrance of the merchant store location, for placement at select locations within the store, for placement within an elevator or public transportation advertising space, for placement at a convention, at an airport, at a bus terminal, at a hotel and/or other similar establishments. In certain instances, the memory tag 107 may be directly affixed to the service, product or good which is for sale and/or a promotion by one or more merchants and/or service providers.

In one embodiment, a user device equipped with a tag reader and/or writer, mobile reader/writer detects the RF memory tag 107, reads the embedded information (e.g., promotional, location, identification, etc.) from the RF memory tag 107 and initiates communication with a tag verification platform 115 and/or a services platform 111 to execute a verification of PoP of the user device. For the purposes of example, the user device may be referred to synonymously with user equipment (UE) 101A. The UE 101 is any type of fixed terminal, mobile terminal, or portable terminal including desktop computers, laptop computers, handsets, stations, units, devices, multimedia tablets, Internet nodes, communicators, Personal Digital Assistants (PDAs), mobile phones, mobile communication devices, digital camera/camcorders, audio/video players, positioning devices, game devices, televisions, and/or the like, or any combination thereof. It is also contemplated that the UE 101 can support any type of interface to the user (such as “wearable” circuitry, etc.) and includes a RF memory tag reader, a camera, a microphone, or other similar input/output (10) component.

A proof of presence (PoP) module 105A performs the necessary functions for enabling reading and/or writing of memory tags 107 as well as for interpreting promotional and/or location information 109A. A reader/writer typically contains a transmitter, receiver, control unit, and an antenna. In addition, the reader/writer may also feature several bytes (e.g., gigabytes) of non-volatile memory such as phase changed memory (PCM) or the like for maintaining data. The reader/writer performs several primary functions: energizing the tag, demodulating and decoding the returned radio signal, and providing clock information. In certain embodiments, a reader/writer includes an additional interface to convert the returned radio signal to a form that can be passed to another system such as a computer or programmable logic controller. As discussed previously, the RF memory tag 107 may be decoded and interpreted to reveal information regarding the object 109 including location, vendor, service provider, text, videos, pictures, audio files, databases, documents, software, and the like for promotional, identification, locationing and the like purposes.

In various embodiments, the RF memory tag 107 is a near field communication (NFC) tag, radio frequency identification (RFID) tag, contactless card, a wirelessly powered RF memory tag, or the like that includes sufficient memory to store promotional information related to the object 109 to which it is affixed (e.g., a bill board, banner, etc.). It is contemplated that the RF memory tag 107 may also be any similar wirelessly powered RF memory tag. By way of example, NFC, RFID, contactless card, and similar technologies are short-range wireless communication technologies that enable the exchange (e.g., both reading and writing) of data between devices and tags over short distances (e.g., the range for NFC is approximately 4 inches). In general, these technologies comprise two main components, a tag (e.g., attached to an object) and a reader/writer (which can be implemented within the UE 101). Communication between the reader/writer and the tags occur wirelessly and may not require a line of sight between the devices. The tag (e.g., an RFID transponder) is, for instance, a small microchip that is attached to an antenna. The tags can vary in sizes, shapes, and forms and can be read through many types of materials.

Moreover, the tags may be passive tags or active tags. Passive tags are generally smaller, lighter, and less expensive than active tags. Passive tags are only activated when within the response range of a reader/writer. In other words, passive tags are typically RF memory tags that are wirelessly powered by the reader/writer. The reader/writer emits a low-power radio wave field that is used to power the tag so as to pass on any information that is contained on the chip. Active tags differ in that they incorporate their own power source to transmit rather than reflect radio frequency signals. Accordingly, active tags enable a broader range of functionality like programmable and read/write capabilities. The read/write capabilities of the RF memory tag 107 can, for instance, enable the system 100 to write comments for storage in the RF memory tag 107 for retrieval by other users or update the content of the RF memory tag 107 to include the latest content. For example, a RF memory tag 107 associated an advertisement can be updated to contain the latest pricing and availability information. In another example, a service provider and/or a merchant may program a RF memory tag 107 with information associated with the location where the RF memory tag is located (e.g., at a convention center, at a store, at a hotel, etc.), with information associated with one or more service providers and/or vendors.

In certain embodiments, the information associated with a RF memory tag 107 can be utilized to interface with one or more user devices wherein the user devices can request and receive one or more information items, for example, location information, memory tag identification information, service provider associated with the memory tag, time, date, and the like. Further, the user device can submit the one or more information items received from the memory tag along with one or more user and/or user device information items (e.g., user name, user ID, user device ID, telephone number, GPS information, time, data, etc.) to a services platform 111 and/or tag verification 115 for verification of proof of presence of the user device indicating that the user device currently is and/or has been at one or more certain locations. Alternatively, the user device may submit the memory tag and user device information to a services platform 111 wherein the services platform 111 can then submit said information to the tag verification platform 115 for verification of proof of presence.

As mentioned previously, the location module 105C can determine a user's location, which can be determined by a triangulation system such as GPS, assisted GPs (A-GPS), Cell of Origin, or other location extrapolation technologies. Standard GPS and A-GPS systems can use GPS satellites 119 to pinpoint the location of a UE 101A. The location module 105C may also utilize multiple technologies to detect the location of the UE 101A, for example, a Cell-of-Origin system can be used to determine the cellular tower that a cellular UE 101A is synchronized with. This information provides a coarse location of the UE 101A because the cellular tower can have a unique cellular identifier (cell-ID) that can be geographically mapped. Location coordinates (e.g., GPS coordinates) can give finer detail as to the location of the UE 101A when one or more location-based services are utilized and synchronized with the communication network 103.

In certain embodiments, the tag verification platform 115 provides various functions for enabling the facilitation of verification of PoP based at least in part on the memory tag and/or user device information. The verification process is performed in connection with a PoP application 105B that provides an interface to the tag verification platform 115. The PoP application 105B is a native or web-based application and/or service that is executable by the user equipment (UE) 101A and includes various application programming interfaces (APIs) for interacting with the operating system (OS) of the UE 101A. By way of example, the PoP application 105B can render to the display of the UE 101A user controls for selecting vendors and/or services of interest, wherein the memory tag 107 and/or a verification of proof of presence may be specific to one or more vendors and/or service providers.

By way of example, the PoP 105B application may be downloaded to or caused to be displayed to (e.g., via a browser application or as web service) UE 101A by the tag verification platform 115. The PoP application 105B may feature one or more logos, designs and other features specific to one or more vendors and/or service providers—i.e., color schemes and affiliated insignia of the vendors and/or service providers to which a verification of PoP is to be submitted to. In addition, the PoP application 105B may be configured to receive input for identifying a particular memory tag 107, including for example, memory tag identifier data, location data and/or other data for identifying the memory tag 107. Consequently, when the user triggers the PoP application 105B to submit a verification of PoP to a vendor and/or a service provider, the PoP application provides notification to the tag verification platform 115 and/or service platform 111 including one or more information items of a user associated with a specific device and/or user profile which may be associated with one or more vendors and/or service providers. Also, the profiles of the user, device, vendor and/or service provider may include, among other data, a unique user identifier, device identifier vendor and/or service provider identifier respectively for distinguishing among a plurality of users, devices and vendors and/or service providers the tag verification platform 115 may interact with.

In various scenarios, the RF memory tag 107 may optionally convey one or more control and/or data signals for causing automated submission of required memory tag and PoP verification information to one or more vendors, service providers, tag verification platform 115, services platform 111 or a combination thereof. As another example, when a user enters a designated merchant location, tapping of the RF memory tag 107 may cause transmission of a wake up alert to the PoP application 105B. The aforementioned executions may be performed, by way of example, in connection with the PoP module 105A that reads the RF memory tag 107. As such, the process of retrieving promotional information, memory tag information, location information and establishing proof of presence for enabling interface with a vendor and/or a service provider is facilitated by a triggering mechanism (tag based or proximity based communication).

In certain embodiments, the PoP 105B for requesting and/or submitting verification of PoP for commencing interface with one or more vendors and/or service providers are implemented according to cloud based computing techniques. By way of example, tag verification platform 115 may be maintained as part of a cloud infrastructure, wherein multiple computing devices (e.g., servers) operate in union over a communication network 103 to enable the sharing and processing of information for a verification of PoP. Hence, in certain embodiments, the tag verification platform 115 may be implemented as a hosted solution by a service provider.

In exemplary embodiments, the tag verification platform 115 provides services to support verification of PoP actions related to the promotional and/or location information contained in the RF memory tag 107. Such actions may include the implementing of access codes to the RF memory tag 107, registering a user, enabling merchants to configure memory tags, etc. In various embodiments, the services platform 111 interacts with the tag verification platform 115 for receiving one or more verifications of PoP associated with one or more user devices.

As shown in FIG. 1, the UE 101A has connectivity to the tag verification platform 115 and services platform 111 through a communication network 103. By way of example, the communication network 103 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

By way of example, the UE 101 communicates with the other devices or components (e.g., tag verification platform 115) on the communication network 103 using well known, new or still developing protocols. In this context, a protocol includes a set of rules defining how the network nodes within the communication network 103 (e.g., UE 101 and services platform 111) interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

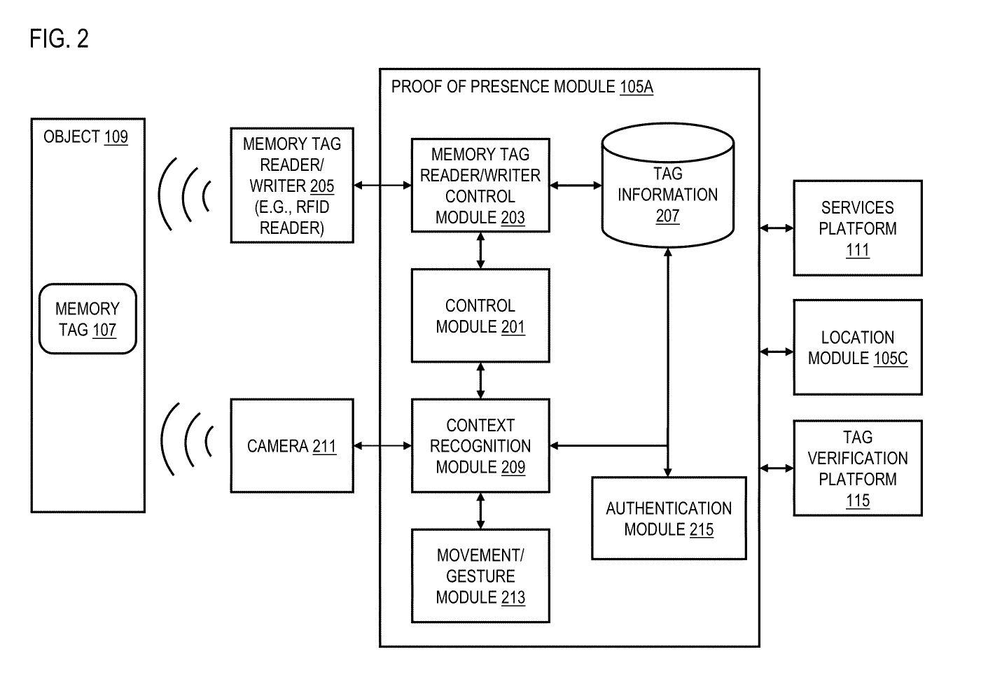

As shown in FIG. 2, the PoP module 105A includes several sub-modules to enhance the object 109 with additional information from the RF memory tag 107. It is contemplated that the functions of the sub-modules may be combined or performed by other components or logic of the UE 101. In exemplary embodiments, the PoP module 105A includes a control module 201 for directing interaction with the RF memory tag 107 for obtaining promotional information related to the object 109 and/or one or more other memory tag information items. The control module 201 may, for instance, interact with a RF memory tag reader/writer control module 203 to detect user input for selecting the RF memory tag 107 in the printed media 109. By way of example, the user input may be indicated by tapping, touching or nearing the UE 101 towards the RF memory tag 107, i.e., tap UE 101 one or more times on, in the direction of or near the RF memory tag 107. The number of taps to initiate a request is configurable by the user, the service provider, or both. It is also contemplated that tapping includes bringing the UE 101 at least sufficiently close enough to the RF memory tag 107 so that the UE 101 can detect a return signal from the RF memory tag 107. A physical tap is not necessary. In addition or alternatively, the user can signal a request to select and read the RF memory tag 107 by activating one or more buttons, applications or menu options on the UE 101, by otherwise causing the UE 101 to read the RF memory tag 107, or by any combination thereof.

After detecting the selection of the RF memory tag 107, the control module 201, for example, causes the RF memory tag reader/writer control module 203 to interact with an RF memory tag reader/writer 205 (e.g., RFID reader/writer, NFC reader/writer, etc.). More specifically, the control module 203, for instance, initiates the reader/writer 205 to download the promotional and/or one or more other information contained in the RF memory tag 107. In certain embodiments, the RF memory tag reader/writer is a component of the UE 101 (e.g., a handset with a built-in reader) in which the tag-based content module 105 resides. In other embodiments, the reader/writer 205 may be an external peripheral attached to the UE 101.

Additionally, in cases where the RF memory tag 107 requires an access code, the control module 201 can provide the access code or request that the user enter the access code before initiating reading of the RF memory tag 107. In certain embodiments, the control module 203 presents one or more functions for enabling proof of presence of RF memory tags for automating the NFC detection process with respect to security and/or offer validation techniques. By way of example, mobile proof of presence may be implemented via the tag based content module and services platform to enable check-in processing and quick response (QR) codes for location verification in addition to near field communication processing. Establishing proof of presence—i.e., verifying the user of a device was actually at a store location at a certain time, on a certain date, for a certain duration and the like where a memory tag 107 is featured—ensures that no duplication, tampering, relocating, or copying (spoofing) of the memory tags has taken place.

In one embodiment, the services platform 111 can provide the access code to the control module 201 automatically. The RF memory tag reader/writer control module 203 stores the read promotional and location information in the tag information database 207. The memory tag information may include an electronic or digital representation of the object 109B (e.g., an electronic version of a hardcopy magazine or catalog), location information, date, time, one or more media files, one or more documents, one or more links to content, purchasing information, advertising information, an electronic catalog, or a combination thereof. If the RF memory tag 107 has write capabilities, the RF memory tag reader/writer control module 203 can direct the reader/writer 205 to write new information to the RF memory tag 107 including, e.g., updating the promotional and location information stored in the RF memory tag 109.

The control module 201 interfaces with a context recognition module 209 that receives image signal input from a camera 211 and a motion signal input from a movement/gesture module 213. In addition or alternatively, the movement may be detected by an accelerometer, radar technology, or another movement sensor. The context recognition module 209 processes the input to determine a context pattern, including a recurring location, activity, device function or mode, etc. The context information may be maintained for use by the tag verification platform 115 as metadata for associating the object 109 with a RF memory tag read for a related item.

In one embodiment, an authentication module 215 authenticates user equipment 101A for interaction with a service provider and/or the tag verification platform 115. By way of example, the authentication module 215 receives a request to provide one or more user device and/or user information items to facilitate a verification of PoP and/or to interface with a service provider. Under this scenario, the authentication module 215 verifies and validates a password, user identification, security code or any other value required for enabling access to specific promotional and/or verification of PoP pertaining to the user. It is noted that the authentication module 215 may access profile data maintained for respective users (subscribers), including the selective recalling, pulling or searching of one or more profile data associated with a given user device that reads a RF memory tag.

The authentication module 215 is also configured to operate in connection with a PoP module 105A for receiving notification of a read memory tag by an authenticated device. Moreover, the authentication module 215 is configured to receive notification that input was provided to tag verification platform 115 operable at a given authenticated (registered) UE 101A in connection with the reading of a memory tag (e.g., proof of presence). A notification by the tag verification platform for the registered UE 101A may include an indication of a vendor and/or service provider identifier with which the memory tag is affiliated, a user and/or device identifier pertaining to the user of the application, or a combination thereof.

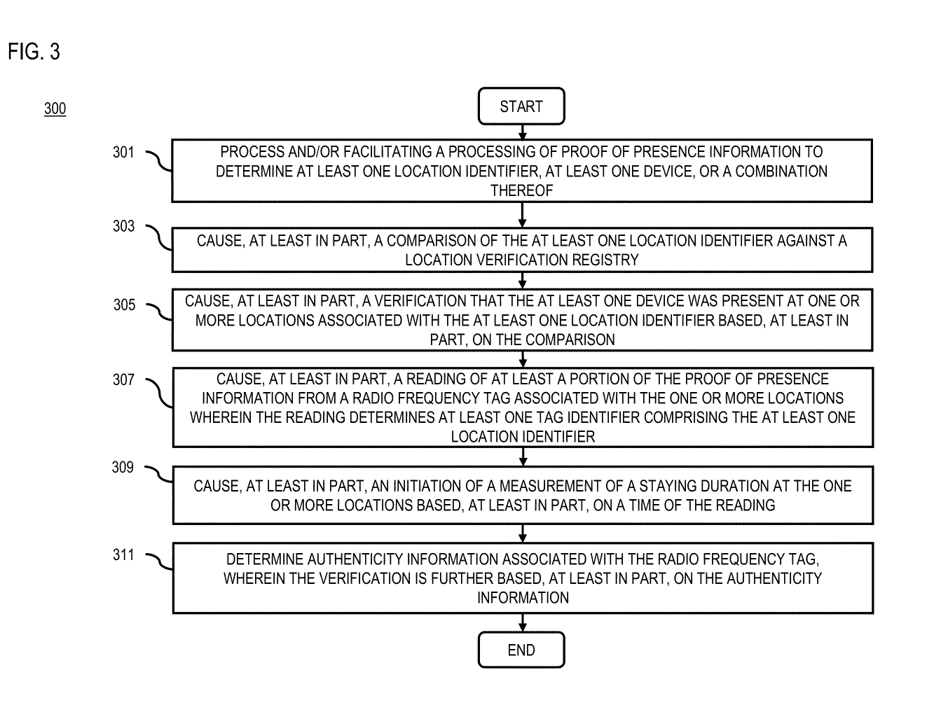

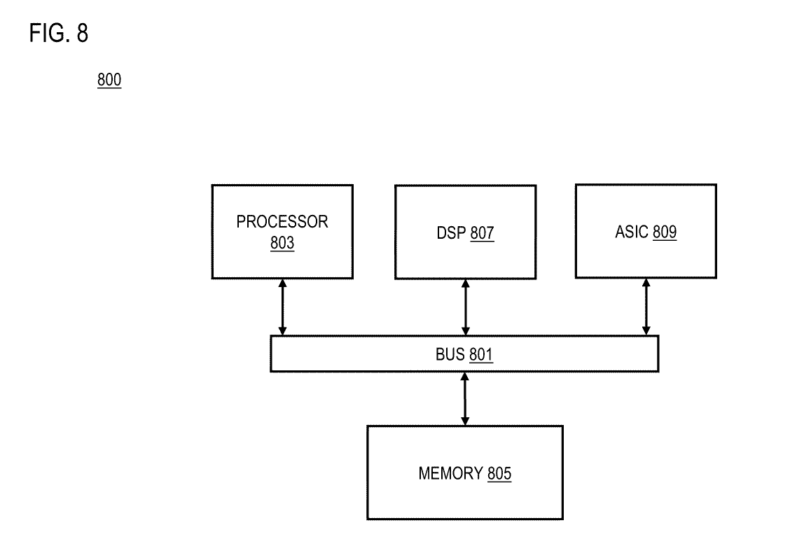

FIG. 3 is a flowchart of a process for processing proof of presence information of a user device, according to one embodiment. In one embodiment, the tag verification platform 115 performs the process 300 and is implemented in, for instance, a chip set including a processor and a memory as shown in FIG. 8. As such, the tag verification platform 115 and/or the control module 201 can provide means for accomplishing various parts of the process 300 as well as means for accomplishing other processes in conjunction with other components of the UE 101 and/or services platform 111.

In step 301, the tag verification platform 115 processes and/or facilitates a processing of proof of presence information to determine at least one location identifier, at least one device, or a combination thereof. In one embodiment, the tag verification platform 115 receives a request for verification of proof of presence (PoP) associated with memory tag and/or a user device. For example a user, a merchant, a vendor and/or a service provider may submit the request along with information associated with the PoP. In various embodiments, the proof of presence information, the at least one location identifier, or a combination thereof includes, at least in part, an image captured at the one or more locations, and wherein the image depicts one or more markers associated with the one or more locations. For example, a print media including a marker (e.g., an image of a personal computer with a “$” on it) may be displayed at a merchant location wherein the image and/or the marker may be associated with one or more vendor locations and wherein said association is stored at one or more databases which may be utilized for verification of the image, marker and location associations. In another example, each vendor/merchant may be assigned and/or associated with a specific image and/or marker which is indicated in the one or more databases. In another embodiment, the one or more markers are variable wherein the one or more markers associated with one or more vendors may be modified and tracked in the one or more databases. For example, a marker assigned/associated with a vendor location may be changed periodically (e.g., hourly, daily, weekly, etc.) so that a prior image and/or a marker captured by a user may or may not be valid such that a user would need to visit a vendor/merchant location in order to capture an updated image and marker to provide for a PoP verification.

In step 303, the tag verification platform 115 causes, at least in part, a comparison of the at least one location identifier against a location verification registry. In one embodiment, the tag verification platform 115 has access to one or more databases wherein information associated with one or more memory tags are stored. Further, the tag verification platform 115 compares one or more memory tag information items, i.e., location information, against the database in order to verify the validity of the location information included in the verification request. In one example, the location information may include GPS coordinates, physical address information, an establishment name or number or a combination thereof.

In step 305, the tag verification platform 115 causes, at least in part, a verification that the at least one device was present at one or more locations associated with the at least one location identifier based, at least in part, on the comparison. In various embodiments, the tag verification platform 115 evaluates the one or more information items included in the verification request in order to ascertain the location of the memory tag, compare to the one or more databases and further ascertain if the user device was or is present at the one or more locations associated with the one or more memory tags. For example, a user may interact with a memory tag at a certain location and cause a request for verification of the PoP. In another example, a service provider may cause the request for the verification of the PoP.

In step 307, the control module 201 causes, at least in part, a reading of at least a portion of the proof of presence information from a radio frequency tag associated with the one or more locations, wherein the reading determines at least one tag identifier comprising the at least one location identifier. In various embodiments, there may be multiple information items associated with a memory tag at a physical location, wherein a user device may read a portion of PoP information (e.g., memory tag location) associated with the memory tag. For example, there may be multiple information items associated with a memory tag wherein at least one information item is indicative of the location of the memory tag, for example, a memory tag is designated and located at a hotel in center city. In various embodiments, integrity of a PoP verification solution may be improved by utilizing a memory tag which has one or more security parameters, for example, the memory tag and/or one or more information items associated with memory tag cannot be can copied, reproduced (e.g., unspoofable) wherein the security parameters may be embedded in the one or more information items, in the memory tag (e.g., hardware, firmware, silicon, etc.). In another example, once the memory tag is programmed with one or more parameters and/or information items; for example, hard-coded into an integrated circuit; wherein an authentication process (e.g., cloud-based) can determine and provide a memory tag ID and one or more other information items (e.g., encoded information) which may be associated together and stored in a database utilized for verification of proof of presence and wherein the one or more information items could not be duplicated after it has been associated and stored in the database. In another embodiment, a vendor and/or service provider would perform a verification process before providing a new authentication for a new memory tag and associated information.

In step 309, the tag verification platform 115 causes, at least in part, an initiation of a measurement of a staying duration at the one or more locations based, at least in part, on a time of the reading. In one embodiment, the tag verification platform 115 may request for the user device to read and submit the memory tag information content multiple times so that the duration of the user device presence at the location can be determined. In another embodiment, the memory tag is able to provide one or more PoP information items that can be utilized to determine duration of the user device presence at the location. In other embodiment, the staying duration is at least one criterion for determining the proof of presence. For example, a service provider may request that a user with his user device need to stay at a certain location for a certain period of time before a PoP can be verified. In various embodiments, the measurement of the staying duration is based, at least in part, on (a) one or more time stamps determined during the measurement, (b) a connection time at the one or more locations, or (c) a combination thereof.

In step 311, the tag verification platform 115 determines authenticity information associated with the radio frequency tag, wherein the verification is further based, at least in part, on the authenticity information. For example, PoP information may include one or more information items related to the memory tag and the user device; however, the information items associated with the tag verification platform 115 needs to validate the one or more information items related to the memory tag to determine, for example, if the memory tag is genuine, original, tampered with, relocated, damaged and the like. In various embodiments, at least one tag identifier is generated based, at least in part, on one or more unique physical properties of the radio frequency tag. For example, a memory tag identifier may indicate that the memory tag is square, round, printed, active, passive, in an enclosure, in a cast and the like. In another embodiment, the authenticity information is determined based, at least in part, on a response to a challenge associated with the one or more unique physical properties, the at least one tag identifier, or a combination thereof.

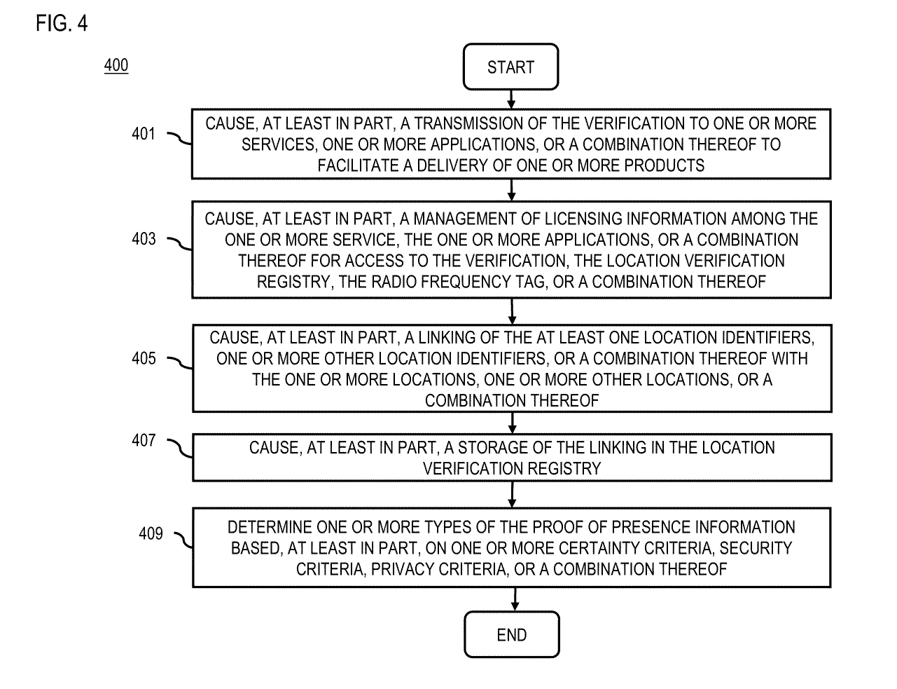

FIG. 4 is a flowchart of a process for submission of the verification of PoP to one or more service providers, according to one embodiment. In one embodiment, the tag verification platform 115 performs the process 400 and is implemented in, for instance, a chip set including a processor and a memory as shown in FIG. 8. As such, the tag verification platform 115 and/or the control module 201 can provide means for accomplishing various parts of the process 400 as well as means for accomplishing other processes in conjunction with other components of the UE 101 and/or services platform 111.

In step 401, the tag verification platform 115 causes, at least in part, a transmission of the verification to one or more services, one or more applications, or a combination thereof to facilitate a delivery of one or more products. In one embodiment, the verification of the PoP is submitted to one or more merchants, one or more service providers or one or more vendors. For example, a verification is sent to several service providers is response to a request by the user wherein the user wishes to notify the service providers in order to compete for one or more services offered by the one or more service providers if a user can complete a sequence of visits to several specific locations. In another example, the verification of the PoP is submitted to an application on the user device wherein the application may further utilize the verification to interface and interact with one or more other applications and/or one or more service providers.

In step 403, the tag verification platform 115 causes, at least in part, a management of licensing information among the one or more service, the one or more applications, or a combination thereof for access to the verification, the location verification registry, the radio frequency tag, or a combination thereof. In various embodiments, the tag verification platform 115 interacts with one or more entities (e.g., service providers, vendors, merchants, etc.) in order to manage entities' utilization of one or more memory tags at one or more locations and the one or more verifications available via the tag verification platform 115. For example, the tag verification platform 115 can verify PoP for a user interfacing with a particular memory tag at a particular location wherein the verification can be provided to multiple entities and wherein the tag verification platform 115 can manage the availability of the verifications to the multiple entities under one or more licensing agreements (e.g., per use, per location, per user, per vendor, etc.)

In step 405, the tag verification platform 115 causes, at least in part, a linking of the at least one location identifiers, one or more other location identifiers, or a combination thereof with the one or more locations, one or more other locations, or a combination thereof. In one embodiment, the tag verification platform 115 assigns one or more location identifies with one or more locations and stores the assignments, for example in one or more local and/or remote databases, for future reference. In another embodiment, the one or more databases can be updated by the tag verification platform 115 and/or a service provider to indicate changes to a memory tag, for example, location, association with one or more entities, relocation, reallocation, and the like.

In step 407, the tag verification platform 115 causes, at least in part, a storage of the linking in the location verification registry. In various embodiment, the tag verification platform 115 may have access to one or more local and/or remote databases wherein the memory tag information (e.g., location, association, ID, origin, manufacturer, etc.) can be stored at the databases for future use and/or reference by the tag verification platform 115 and/or a service provider.

In step 409, the tag verification platform 115 determines one or more types of the proof of presence information based, at least in part, on one or more certainty criteria, security criteria, privacy criteria, or a combination thereof. In various embodiments, one or more vendors and/or service providers may request one or more different types of verifications. For example, a vendor may plan to offer different promotional items based on a type of verification of PoP for a user, for example, a high value offer is made to user whom can have a PoP verification at a higher level such as PoP verification based on user information, user device information, GPS location information, memory tag information, time and data information and the like. Further, vendors and service providers may be willing to provide products and/or services to a user at a more personal level if the PoP verification can assure that a user is willing to provide certain user privacy information. In another example, a verification of PoP may include higher level of security verification to ensure that an offer intended for a particular user is utilized by the intended user.

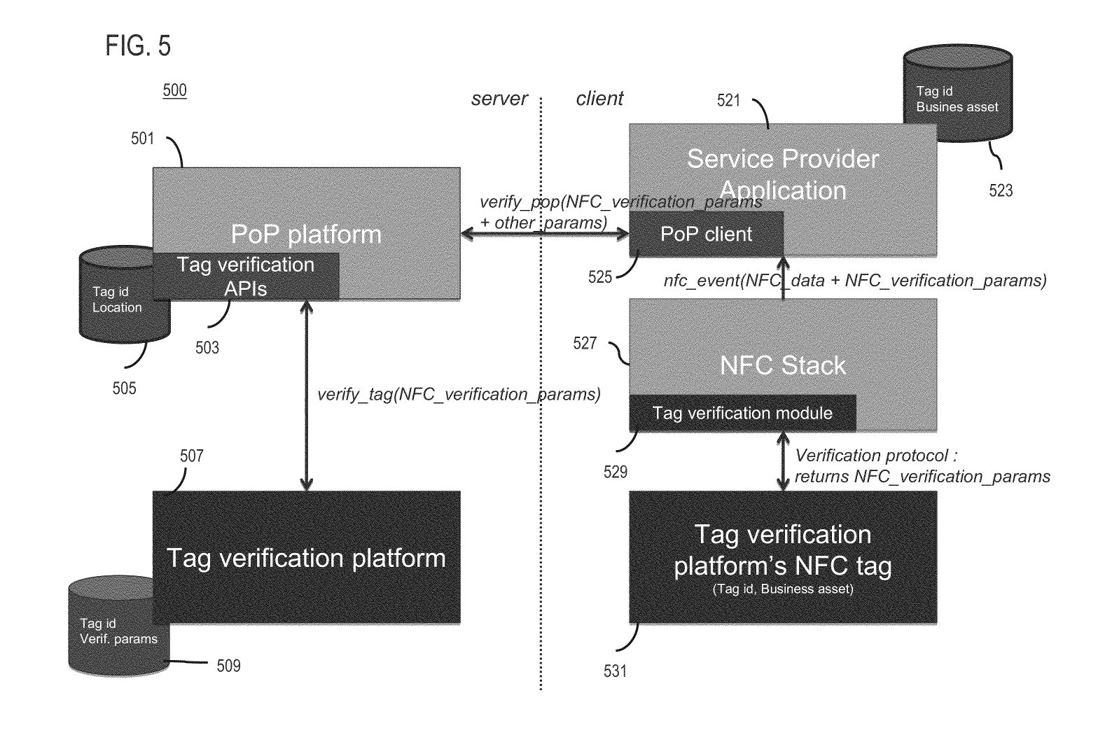

FIG. 5 depicts example architecture 500 of proof of presence with a service provider application. In one embodiment, a user device PoP client 525 initiates a NFC memory tag read event wherein client's NFC stack 527 determines a type of the memory tag and initiates one or more appropriate memory tag verification algorithms for a NFC based verification. Further, a tag verification module 529, if needed for the tag verification algorithm, reads one or more parameters (e.g., including memory tag ID, content, proprietary verification parameters) from the memory tag while the user device is in communication with the memory tag including one or more NFC data items. The NFC verification parameters and the one or more read NFC data items are submitted to one or more service provider applications which may require the one or more NFC data items. Furthermore, service provider application 521 can, with or without a knowledge of verification details, may request the PoP platform 501 to verify the memory tag. Moreover, NFC verification parameters are passed to PoP platform 501 wherein the PoP platform client 525 may also send other verification parameters along with the request related to the environment to further enhance the PoP algorithms. Furthermore, the PoP platform 501 may process the one or more verification parameters and initiate the one or more related PoP verification algorithms, for example, including a request to tag verification platform 507 with NFC verification parameters to verify the memory tag. Additionally, the verification platform 507 executes one or more verification algorithms and responds back with one or more verification detail items of the memory tag (e.g., verified/not verified and optional additional details related to the memory tag ID). Further, the PoP platform 501 may continue the execution of the one or more PoP algorithms taking into account one or more responses from the tag verification platform 507 and one or more results to the service provider application 521 (e.g., verified, not verified, additional details related to the memory tag ID). Moreover, based, at least in part, on one or more results of the PoP verification request, the service provider application 521 may initiate one or more actions, for example, accept the memory tag and execute one or more related business assets linked to the memory tag ID or, at least in part, disregard the memory tag.

In various embodiments, the PoP platform 501 and the tag verification platform 507 may be substantially implemented in one device wherein related security implementation parameters are in place. Further, the PoP platform 501 may implement multiple algorithms for PoP verification. Furthermore, the tag verification platform 507 may be implemented by a same entity as the PoP platform 501 to enable one or more possible ecosystem opportunities. Moreover, the PoP platform 501 may execute several verification algorithms at the same time (e.g., Verayo© verification, GPS, black/white lists, WLAN, history based tracking, etc.) based on the one or more parameters available in a verification request. Additionally, the PoP platform 501 may also send additional details related to the memory tag ID to the service provider application 521, for example to create dynamic content handling and authorization system for the applications (tag ID is the only identification needed to link dynamic content to it). Furthermore, the PoP client 525 may also be integrated into the NFC stack 527 or a similar system component wherein the system component would verify the memory tag with the PoP platform 501 and submit the verified memory tags to one or more service provider applications 521.

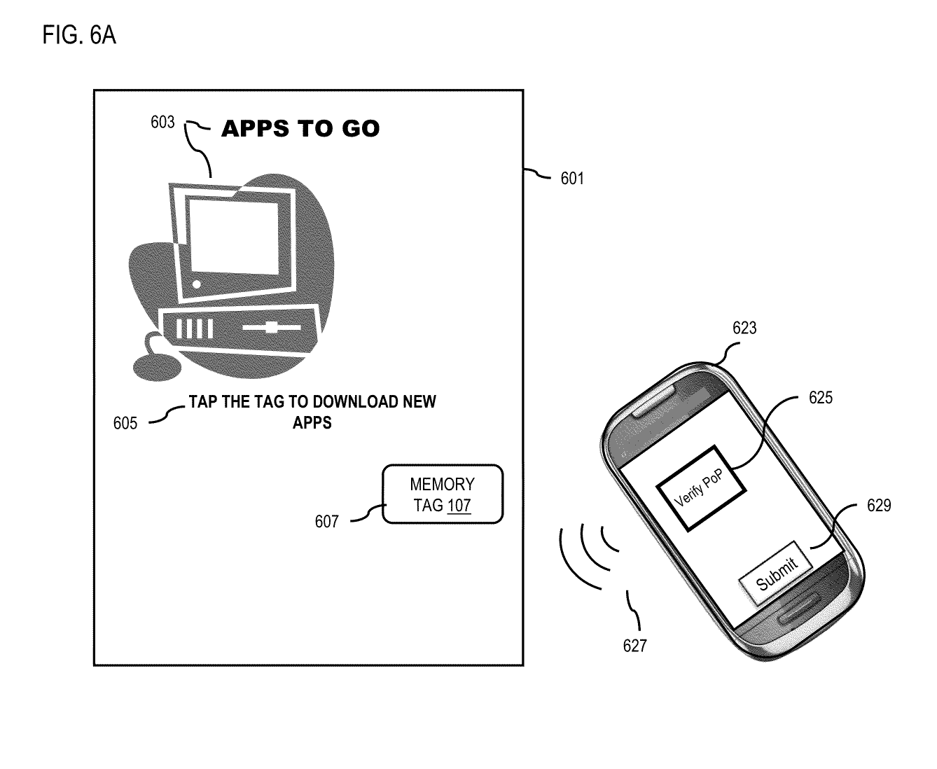

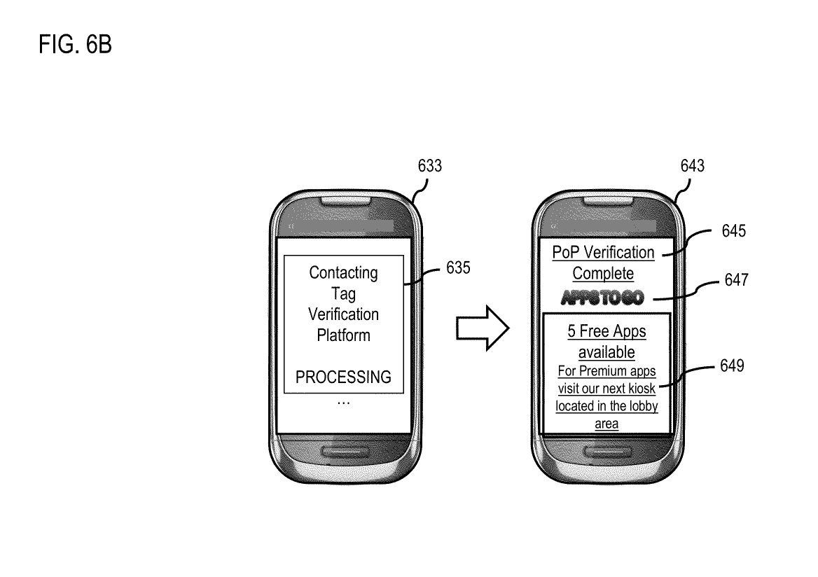

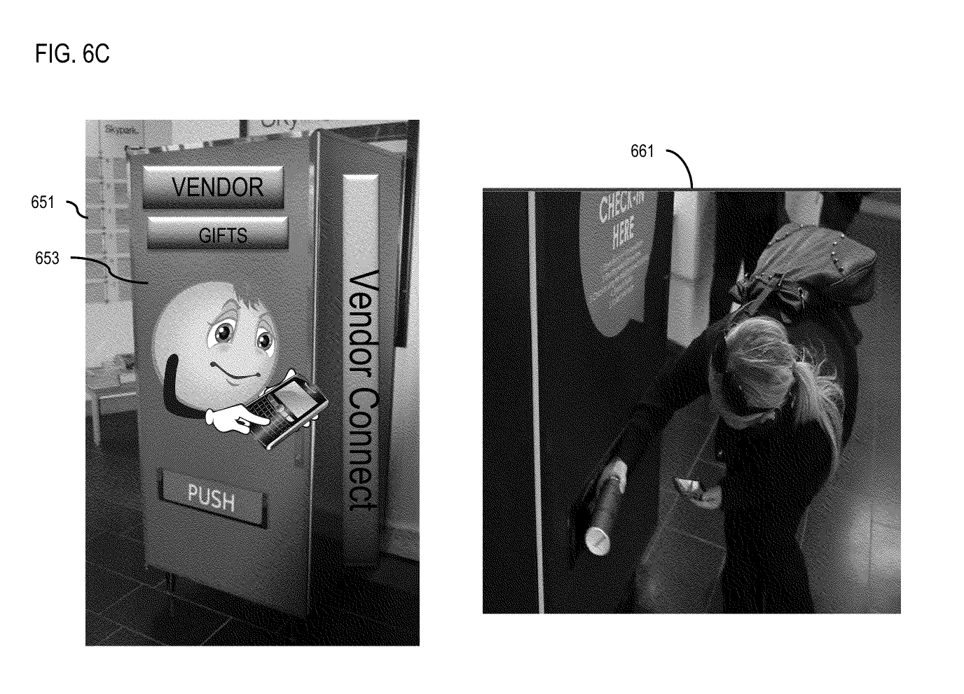

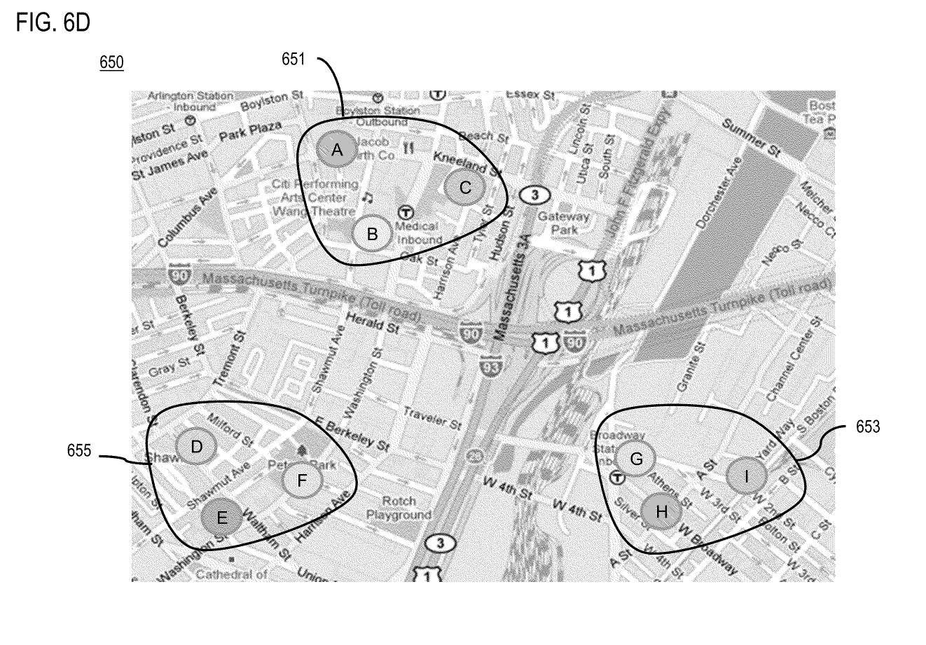

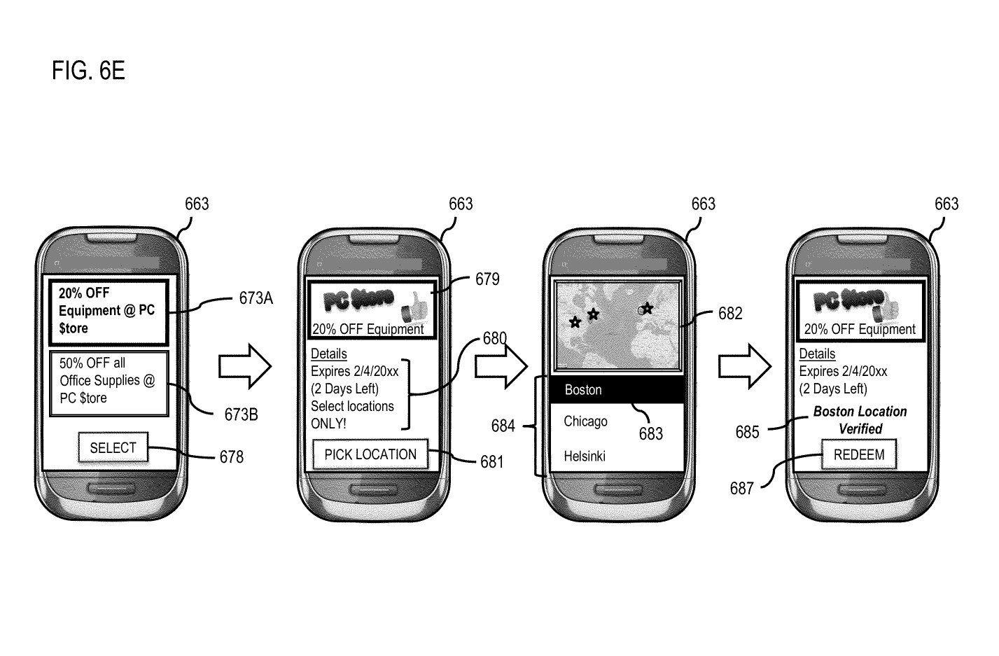

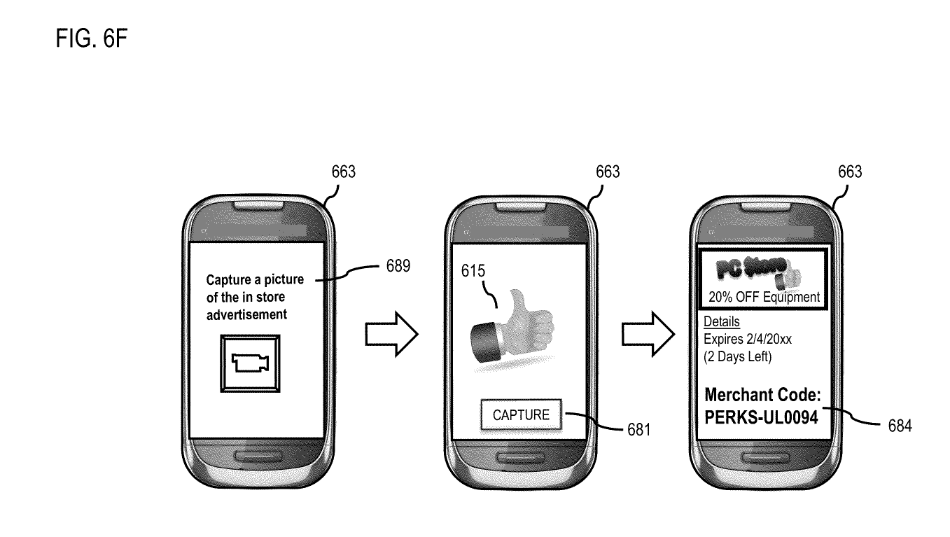

FIGS. 6A-6F are diagrams of user interfaces utilized in the processes of FIGS. 3 and 4, according to various embodiments.

FIG. 6A depicts an item of article 601 which has a memory tag 107 associated with it as well as user device 623 for communication with the memory tag 107. In one embodiment, the article 601 is located at a certain geographical area (e.g., at center city) and at a certain establishment (e.g., at a coffee shop). The article 601 may be a poster, a billboard, a kiosk, a media item and the like which presents one or more information item and 603 (e.g., name a vendor “APPS TO GO” and its logo) and one or more instructions 605 for one or more users to view and interact with. The user device 623 is capable of communication with the memory tag 107 via one or more wireless connections (e.g., NFC) 627. Further, the user device includes one or more applications 625 which can be utilized for interfacing with the memory tag 107. In one use scenario, a user utilizes the user device 623 to read one or more information items; for example, a location information, memory tag ID, date, time, vendor information, one or more available offers; contained in the memory tag 107. Further, the user and/or the user device can cause a request to verify PoP via application 625 and submit it 629 to a tag verification platform, to one or more vendors and/or one or more service providers. For example, a user may wish to download one or more available applications via the vendor “APPS TO GO” wherein the vendor request to verify PoP of the user before providing access to the one or more applications.

FIG. 6B depicts a user interfaces (UI) 633 and 643 for a user and a user device to interface with a tag verification platform, one or more vendors and/or service providers. In one use scenario, the UI 633 shows a status 635 wherein an indication that one or more applications on the user device are contacting a tag verification platform to submit a request for verification of PoP. Further, the UI 643 shows that PoP verification is complete at 645 with further messages 647 and 649 wherein at 649 one or more apps are available for free download with additional premium apps being available to the user if the user chooses to visit a next kiosk (e.g., in the lobby area at the current location). As in the example, a vendor and/or a service provider can make one or more premium offers available to one or more users with additional criteria such as multiple verifications of PoP from different visits at different times and/or at different locations, additional user information, additional user device information, additional tasks completed by the user and/or the user device.

FIG. 6C shows an illustration 651 which includes an item 653 (e.g., a kiosk) that is associated with a vendor and one or more memory tags (e.g., inside the kiosk). In this example, the kiosk is utilized by a vendor to provide gift items (e.g. as s promotion) to users if the users visit the kiosk at 661, read the memory tag information and submit for a verification of PoP. In an example setting, one or more vendors and/or service providers may use one or more kiosks and one or more memory tags to provide a regular and premium promotional items and/or services as part of a promotional campaign, for example, at a shopping mall, at an airport, at a convention center, at a hotel and the like. For example, for a user to qualify for a premium gift from the kiosk, one way to qualify could be to check-in at a special kiosk (e.g., a vendor booth) at a special location (e.g., at a demo venue) by tapping (e.g., NFC) the memory tag (e.g., “Check-in here” tag) with a user device that at least has an application capable of communication with the vendor kiosk. This step can present a special offer that will instruct the user to go and check-in at a vending machine to receive a gift (i.e., on the condition that the user is utilizing an application approved by the vendor). Further, when checking-in at the vending machine by tapping a memory tag on the machine, the PoP application will detect whether the user is eligible for a gift (i.e. has checked in at the demo venue using NFC memory tag) and if the user has not already received a gift and has a valid check-in to one of the demo stands, the vending machine will dispense a gift. Further, one or more other criteria such as frequency of user visits at the vendor kiosk, duration of each visit, sequence of visitation of the kiosk and the like could qualify the user for a more premium offer/gift (e.g., a smartphone).

FIG. 6D shows a map of a geographical area wherein several points of interest (POI) A-I in three groupings of 651, 653 and 655 are indicated. In various embodiments, the POIs may be associated with one or more vendors and/or service providers (entities) wherein each POI may have one or more memory tags associated with the one or more entities. Further, each entity may have one or more marketing campaign to encourage users to visit the one or more POIs for receiving one or more offerings. Additionally, the requirements by each entity for receiving one or more offerings may vary and be specific to each entity. For example, one entity may require that a user to visit each POI during a certain time, day, at a specific pattern, for a particular amount of time and present a certain level of verification of PoP (e.g., high) before an offer is made available to a user. In another embodiment, multiple entities can utilize a same promotional campaign wherein a user has to select an entity at each site visit for presenting a verification of PoP before moving on to the next POI.

FIG. 6E depicts UI presentations for a verification process wherein PoP and/or location information regarding the user device 663 are validated in order to enable access to an example promotional information.

In various embodiments, a user may receive and/or view various coupons 673A and 673B which may be offered by one or more merchants, vendors, service providers and the like. The user can select a particular coupon of interest by activating a “SELECT” action button 678. For example, when the user selects coupon 673A corresponding to an offer from a PC store, the user display is caused to present details 680 regarding the offer. The details may include descriptive text representative of a date of offer expiry, the number of days left for use of the coupon, a digital depiction of the coupon 679, etc. Also included within the detail description 680 is an indication that the offer is only valid at one or more select locations. Further, the user may select a “PICK LOCATION” action button 681 to initiate a viewing of the select one or more locations wherein the coupon is valid. Furthermore, in response to selecting the action button 681, the UI presents a listing of one or more locations corresponding to the coupon. A mapping application 682 is utilized to present the various store locations wherein the coupon may be applied. In addition, a listing 684 of the available locations is presented for selection by the user. Moreover, when the user selects a particular option, i.e., Boston 683, this action triggers, at least, an activation of a location service (e.g., GPS service) for verifying PoP and/or location of the user device 663. When a match is found between the present location of the device and the store location, the UI is updated to indicate that the location is verified 685. The user may then redeem the coupon by selecting a “REDEEM” action button 687.

In FIG. 6F, as further verification of proof of presence and/or coupon redemption processing, the user is presented with a message 689 prompting the user to capture an image (e.g., picture, video, etc.) of the advertisement corresponding to the item of interest. The message may also include a warning prompt indicating to the user that one or more different (e.g., with better focus, closer view, etc.) images must be captured in order to further enable verification of PoP and/or validation of the coupon. By way of example, the user captures an image of the logo 615 corresponding to an in-store advertisement for a merchant (e.g., PC $tore). Further, he user may be required to capture an image of the entire poster, one or more codes featured on the poster, one or more markers, one or more logos and the like associated with the location of the merchant, vendor, POI and the like. It is noted in certain embodiments that a user may also be prompted to read one or more memory tags 107 affixed to the poster 601 in FIG. 6A as part of one or more PoP and/or verification/redemption processes. Furthermore, the capture process is facilitated by selecting a “CAPTURE” action button 681, which causes an image capturing module (e.g., a camera) on the user device to capture an image which can be submitted to one or more service providers and/or the tag verification platform 115 for PoP verification and coupon processing. Moreover, the one or more location information, the one or more memory tag information items, the user device location information (e.g., GPS), the image or a combination thereof can be utilized to verify proof of presence (e.g., validate weather user is in the store and location where he claims to be) wherein a merchant code 684 is presented along with the coupon information for presentation to the merchant. While the processing of the location information, PoP and image information are shown herein as separate processes, they may be performed concurrently as a means of executing verification of proof of presence.

By way of the processes described herein, a user may advantageously perform verification of proof of presence by way of reading an RF memory tag associated with a location and submitting a request via the PoP application 105B. The tag verification platform then executes the verification process automatically, utilizing the communication network, data maintained regarding the memory tag, merchant, service provider and user, and communication channels with the various services providers.

The processes described herein for facilitating a verification of proof of presence of a user device may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

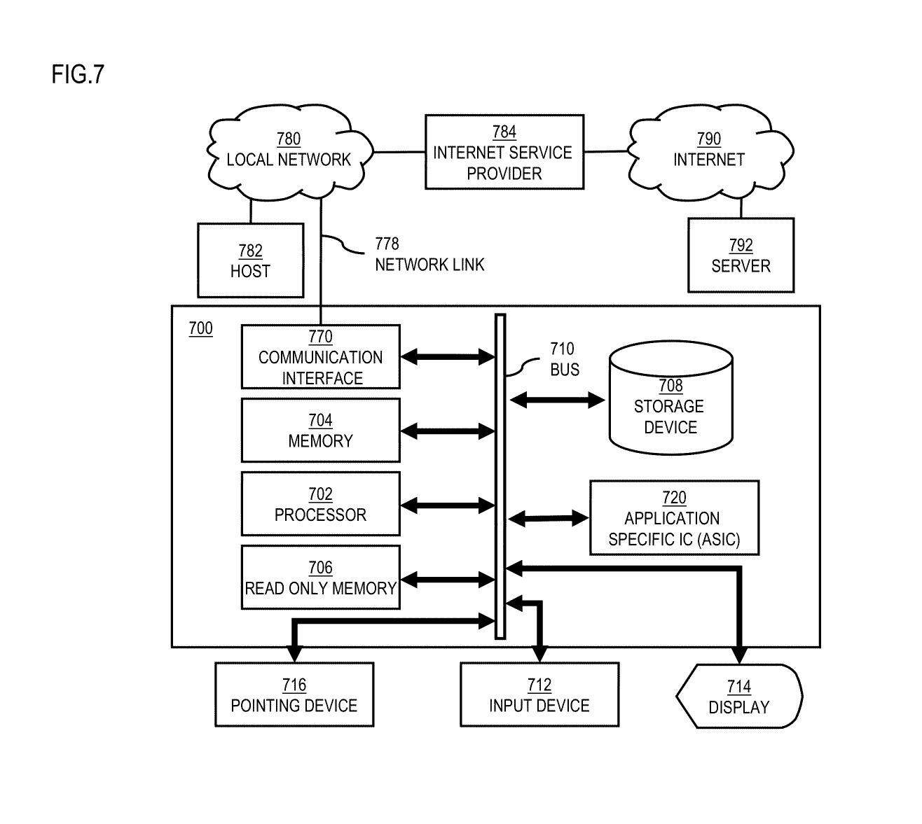

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to facilitate a verification of proof of presence of user device as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of facilitating a verification of proof of presence of a user device.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to facilitate a verification of proof of presence of a user device. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or any other dynamic storage device, stores information including processor instructions for facilitating a verification of proof of presence of a user device. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or any other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for facilitating a verification of proof of presence of a user device, is provided to the bus 710 for use by the processor from an external input device 712, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT), a liquid crystal display (LCD), a light emitting diode (LED) display, an organic LED (OLED) display, a plasma screen, or a printer for presenting text or images, and a pointing device 716, such as a mouse, a trackball, cursor direction keys, or a motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of ASICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for facilitating a verification of proof of presence of a user device to the UE 101.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or any other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed to facilitate a verification of proof of presence of a user device as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for performing one or more steps of facilitating a verification of proof of presence of a user device.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to facilitate a verification of proof of presence of a user device. The memory 805 also stores the data associated with or generated by the execution of the inventive steps.

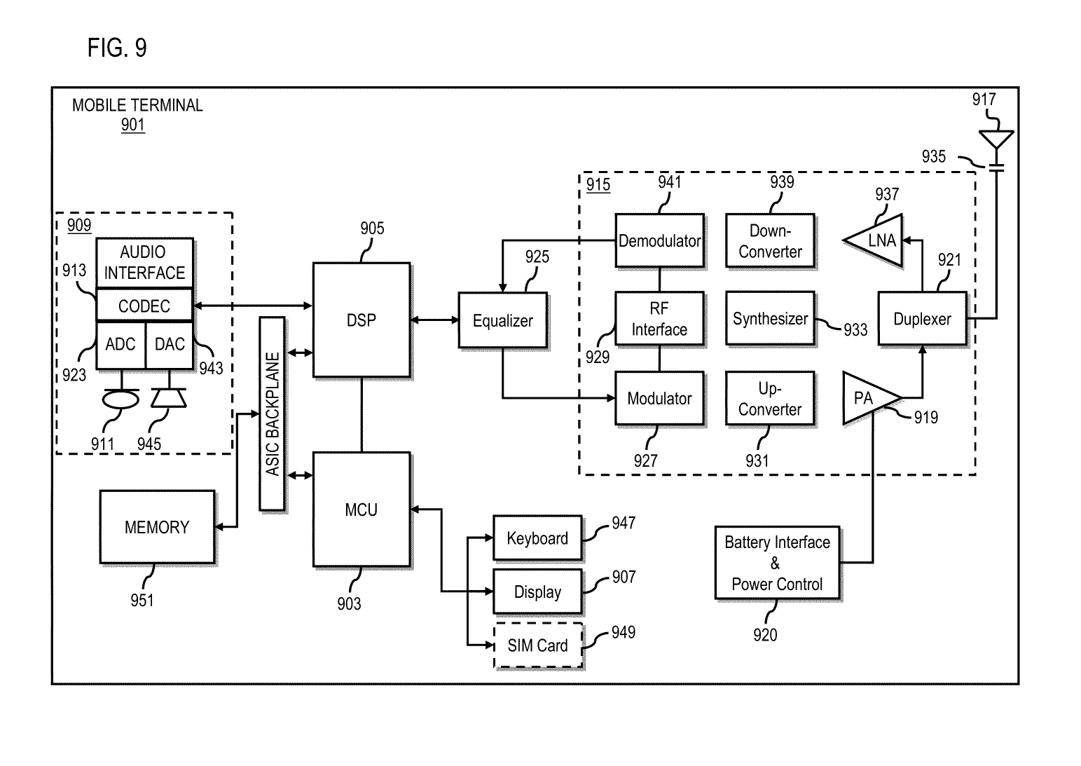

FIG. 9 is a diagram of exemplary components of a mobile terminal (e.g., handset) for communications, which is capable of operating in the system of FIG. 1, according to one embodiment. In some embodiments, mobile terminal 901, or a portion thereof, constitutes a means for performing one or more steps of facilitating a verification of proof of presence of a user device. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MUCH) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of facilitating a verification of proof of presence of a user device. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903 which can be implemented as a Central Processing Unit (CPU).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to facilitate a verification of proof of presence of a user device. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a processing of proof of presence information to determine at least one location identifier, at least one device, or a combination thereof;
a comparison of the at least one location identifier against a location verification registry; and a verification that the at least one device was present at one or more locations associated with the at least one location identifier based, at least in part, on the comparison.

2. A method of claim 1, wherein the (1) data and/or (2) information and/or (3) at least one signal are further based, at least in part, on the following:
a reading of at least a portion of the proof of presence information from a radio frequency tag associated with the one or more locations,
wherein the reading determines at least one tag identifier comprising the at least one location identifier.

3. A method of claim 2, wherein the (1) data and/or (2) information and/or (3) at least one signal are further based, at least in part, on the following:
an initiation of a measurement of a staying duration at the one or more locations based, at least in part, on a time of the reading.

4. A method of claim 3, wherein the staying duration is at least one criterion for determining the proof of presence.

5. A method of claim 3, wherein the measurement of the staying duration is based, at least in part, on (a) one or more time stamps determined during the measurement, (b) a connection time at the one or more locations, or (c) a combination thereof.

6. A method of claim 2, wherein the (1) data and/or (2) information and/or (3) at least one signal are further based, at least in part, on the following:
a determination of authenticity information associated with the radio frequency tag, wherein the verification is further based, at least in part, on the authenticity information.

7. A method of claim 6, wherein at least one tag identifier is generated based, at least in part, on one or more unique physical properties of the radio frequency tag, and wherein the authenticity information is determined based, at least in part, on a response to a challenge associated with the one or more unique physical properties, the at least one tag identifier, or a combination thereof.

8. A method of claim 1, wherein the (1) data and/or (2) information and/or (3) at least one signal are further based, at least in part, on the following:
a transmission of the verification to one or more services, one or more applications, or a combination thereof to facilitate a delivery of one or more products.

9. A method of claim 8, wherein the (1) data and/or (2) information and/or (3) at least one signal are further based, at least in part, on the following:
a management of licensing information among the one or more service, the one or more applications, or a combination thereof for access to the verification, the location verification registry, the radio frequency tag, or a combination thereof.

10. A method of claim 1, wherein the (1) data and/or (2) information and/or (3) at least one signal are further based, at least in part, on the following:
a linking of the at least one location identifiers, one or more other location identifiers, or a combination thereof with the one or more locations, one or more other locations, or a combination thereof; and
a storage of the linking in the location verification registry.

11. A method of claim 1, wherein the (1) data and/or (2) information and/or (3) at least one signal are further based, at least in part, on the following:
a determination of one or more types of the proof of presence information based, at least in part, on one or more certainty criteria, security criteria, privacy criteria, or a combination thereof.

12. A method of claim 1, wherein the proof of presence information, the at least one location identifier, or a combination thereof includes, at least in part, an image captured at the one or more locations, and wherein the image depicts one or more markers associated with the one or more locations.

13. A method of claim 12, wherein the one or more markers are variable

14. An apparatus comprising:
at least one processor; and
at least one memory including computer program code for one or more programs,
the at least one memory and the computer program code configured to, with the at least one processor, cause the apparatus to perform at least the following,
process and/or facilitate a processing of proof of presence information to determine at least one location identifier, at least one device, or a combination thereof
cause, at least in part, a comparison of the at least one location identifier against a location verification registry; and
cause, at least in part, a verification that the at least one device was present at one or more locations associated with the at least one location identifier based, at least in part, on the comparison.

15. An apparatus of claim 14, wherein the apparatus is further caused to:
cause, at least in part, a reading of at least a portion of the proof of presence information from a radio frequency tag associated with the one or more locations,
wherein the reading determines at least one tag identifier comprising the at least one location identifier.

16. An apparatus of claim 15, wherein the apparatus is further caused to:
cause, at least in part, an initiation of a measurement of a staying duration at the one or more locations based, at least in part, on a time of the reading.

17. An apparatus of claim 16, wherein the staying duration is at least one criterion for determining the proof of presence.

18. An apparatus of claim 16, wherein the measurement of the staying duration is based, at least in part, on (a) one or more time stamps determined during the measurement, (b) a connection time at the one or more locations, or (c) a combination thereof.

19. An apparatus of claim 15, wherein the apparatus is further caused to:
determine authenticity information associated with the radio frequency tag,
wherein the verification is further based, at least in part, on the authenticity information.

20. An apparatus of claim 19, wherein at least one tag identifier is generated based, at least in part, on one or more unique physical properties of the radio frequency tag, and wherein the authenticity information is determined based, at least in part, on a response to a challenge associated with the one or more unique physical properties, the at least one tag identifier, or a combination thereof.

21-60. (canceled)
